(19) United States
(12) Patent Application Publication
(10) Pub. No.: US 2025/0131806 A1
(43) Pub. Date: Apr. 24, 2025

(54) EARLY FIRE DETECTION DEVICE AND METHOD FOR RECHARGEABLE LITHIUM-ION BATTERIES

(71) Applicant: Soteria Battery Innovation Group, Inc., Greenville, SC (US)

(72) Inventors: Benjamin G. Fuller, Greer, SC (US); Ben Hartings, Greenville, SC (US); Drew J. Pereira, Greenville, SC (US); Brian G. Morin, Greenville, SC (US); Ashwin Pitts, Greenville, SC (US)

(21) Appl. No.: 18/381,638

(22) Filed: Oct. 19, 2023

(51) Int. Cl. G08B 17/10

(52) U.S. Cl. CPC G08B 17/10

(57) ABSTRACT

A device and system thereof to provide early warning and potential shutdown of a charging consumer device including a rechargeable battery (i.e., lithium-ion) in the event of a possible thermal runaway are disclosed herein. Such a device includes a sensor to detect degassing of emitted carbon dioxide or hydrogen gas at a nanoparticle level as an indication of the initiation of such a possible flame presence due to such a thermal runaway event. Such a system thus incorporates such an overall device present within a close proximity to a rechargeable battery (or batteries) as a means to provide an early warning of such a potentially catastrophic situation to permit a user the capability of detaching or unplugging such a rechargeable battery and/or at least the chance to move the consumer device to a safer location. The method of utilizing such a device and system thereof is encompassed herein as well.

### FIELD OF THE DISCLOSURE

Disclosed herein is a device and system thereof to provide early warning and potentially shutdown of a charging consumer device including a lithium-ion or other type of rechargeable battery in the event of a possible thermal runaway. Such a device includes sensors to detect degassing of emitted carbon dioxide and/or hydrogen gas at a molecular level as an indication of the initiation of such a possible flame presence, or even an early warning due to such a thermal runaway event. Such a system thus incorporates such an overall device present within a close proximity to a rechargeable battery, or batteries, as a means to provide an early warning of such a potentially catastrophic situation to permit a user the capability of detaching or unplugging such a rechargeable battery, and/or at least the chance to move the consumer device to a safer location, as well as potentially evacuating from the premises before bodily harm occurs. The method of utilizing such a device and system thereof is encompassed herein as well.

### BACKGROUND OF THE PRIOR ART

Rechargeable batteries have been utilized for decades ostensibly as a way to avoid the need to continue the purchase of alkaline types. Certainly, the ability to permit electrical device usage with freedom of motion has become an expected luxury with the ability to provide rechargeable batteries a further benefit for users the world over. From the initial nickel-cadmium (NiCad) to incredibly popular lithium-ion and with certain innovations in sodium-ion and other like batteries, the continued growth of the rechargeable industry seems to be unending.

Of major concern, however, is the potential for catastrophic events from faulty manufacturing and/or below-standard materials associated with such rechargeable devices. Batteries generally include an anode, a cathode, a current collector, a flammable liquid electrolyte, an internal separator typically comprising thermoplastic between the anode and cathode and leads to external connections for utilization with a charge-requiring device. Problems have existed, at least, with separators that are of poor quality, improperly cut, aligned, or otherwise structured having undesirable formations. In various situations, the thermoplastic separators may allow shorts within the battery leading to uncontrollable voltage and the aforementioned thermal runaway events wherein the short creates a spark which causes a flame due to the presence of flammable electrolyte. Recently discovered, as well, is that commonly used metallic current collectors contribute to such thermal runaway issues as the metal components allow for voltage to continue through the target battery upon such a short, thus providing further a source to thermal runaways. New, novel thin-film current collectors have been developed to overcome such problems, imparting a capability to stop a short immediately within such a battery at the actual location of the problem without appreciably affecting the battery function. As it is, though, the continued usage of thick metal current collectors has not yet fully abated and manufacturers continue to utilize cheaper products, particularly with separators and current collectors, at least, leading to further thermal runaway problems that are reported almost daily. Such a problem within this industry is thus quite significant.

These issues have been widely reported and continue to this day to be seriously problematic. For instance, hoverboards were notoriously denigrated a few years ago as they seemed to consistently, at least in certain proportions, ignite during charging or even actual use, causing not only product destruction but fires within houses, cars, etc. Lately, rechargeable mobility devices, including e-bikes, scooters, carts, and the like, have proven susceptible to such thermal runaway events. With the popularity of such devices increasing, the need to protect consumers from the problems associated with these poorly manufactured rechargeable batteries grows, as well.

Such a problem is not limited to consumer utilization of rechargeable electric devices. The shipping of such devices has also proven to exhibit certain issues as packing/shipping containers (containing multiple devices in close relation to one another) may incur internal thermal runaway events even from a single rechargeable device. Such a situation, again, even from a single device, may cause the contents of such a packing/shipping container to suffer untold damage due to a quick onset of a flame-based event. The batteries therein, for instance, still contain a charge and voltage during shipping and thus may exhibit problems, particularly due to shifting or other forces during transport that may lead to punctures or other possible damage that may cause internal battery distortions that may lead to thermal runaway events. An alert, particularly and potentially associated with the shipping container itself, and related to gas release from a battery before thermal runaway occurs, may help to reduce such damage. It is not known if any such system has been proposed to date.

Certain solutions have been attempted but have lacked suitable and reliable results that provide definitive benefits to consumers. For instance, a system totally present within a battery housing has been suggested including a detector for certain particles and gases associated with thermal runaway situations and a microcontroller and to control the battery in relation to a detected problem. Such a system, unfortunately, lacks a suitable means to warn a consumer and relies solely upon the ability of the microcontroller to shut down the battery. Of course, in the event a thermal runaway occurs, the need to provide a warning to allow for external actions to commence, by the consumer for example, permits far greater safety overall, particularly if the battery controlling aspect fails or is insufficient for full activity for complete safety in the vicinity of the consumer device itself. Other devices have been suggested in similar manners, particularly with a gas detection component that activates a processing unit upon the presence of a gas above a certain threshold, with one providing gas sensitivity at nanoparticle levels. Again, however, these developments are present within the battery housing itself and not external to the battery, thus presenting a distinct problem, as alluded to above, that destruction of the detection component if not controller, even potential communication capability, may occur too quickly to be of definitive benefit in case of a thermal runaway event. Yet another suggested manner of detection has been proposed utilizing a fire retardant or extinguishing agent within a pack of pouch cells. Upon swelling or expansion due to gas release, apparently, a sensor controls the release of such fire retardant, etc., chemicals to deter flames within the cells themselves. As noted above, however, such devices are within the cells themselves and provide no outward warning to a consumer and the apparent hope is that the chemicals released will abate the fire during such a thermal runaway event before an explosion or other catastrophe occurs.

Clearly, there is a definite need for improvements within this area. The continued reports of fires from rechargeable batteries within consumer products certainly indicates the necessity for better ways to protect consumers from harm, particularly if manufacturers unfortunately continue to assemble and sell below-quality batteries. The ability to provide an external detection device with an early warning capability is thus of great importance. To date, nothing has been provided to such an extent within the pertinent industries. This disclosure provides a significant movement towards overall consumer protection in this area.

### Advantages and Summary of the Disclosure

A distinct advantage of the disclosure herein is the capability of such a device and system thereof to provide an early alert to a consumer that a thermal runaway event is imminent through the external presence of the device from the associated rechargeable battery as well as a high-decibel warning provided thereby upon detection of gases released from such a battery. Another advantage of the disclosure is the ability to provide such a device and system thereof separate from the rechargeable battery to which it would be associated in order to permit placement in sufficiently close proximity to such a battery and thus control thereof by the consumer. Another advantage is the potential use of a single device to provide protection for more than one, or many batteries. Yet another advantage is the ability to have the device not add weight and cost to the battery, which may need to be mobile and also have a limited lifetime much shorter than that of the device. Yet another advantage of the disclosure herein relates to the combination of a sensor for early detection of carbon dioxide and/or hydrogen gases from the target battery at a level relating to early onset of a thermal runaway event, thereby allowing for definitive detection above a minimal threshold of such emissions. Another advantage is to detect these same gases before they reach levels, in a confined space, which could be toxic or explosive in the absence of thermal runaway. Still another advantage is the capability of a consumer to be properly alerted to the necessity for external action of a rechargeable device prior to a catastrophic event rather than relying upon an internal battery device controller, for instance, to be the only line of defense and thus warning of any such problem.

Accordingly, this disclosure encompasses an early warning device for placement within a proximity of a rechargeable battery housing associated with an electrical device, said early warning device comprising: a housing encompassing at least one sensor for nanosize detection of carbon dioxide and/or hydrogen gas or other gases emitted from the housing during a lithium-ion battery venting event, including, without limitation, carbonates and other volatile organic compounds with an opening for passage of gases from said housing directed towards at least one sensor which is separate from said housing. Said nanosize detection would naturally include molecular detection as well. Preferably a fan is in flow communication with the opening in the housing to direct gases from the housing opening towards the sensor. A high-decibel high-pitch noise emitting component, is optionally attached to the housing to the sensor or in a stand-alone location in functional communication with the sensor to alert when a predetermined threshold is reached. Ann electrical distribution component is further provided to transfer an electrical charge to at least one sensor, the fan, and the noise-emitting component through a functional relay or switch for activation thereof. A plug component is preferably connected to the electrical distribution component; wherein said noise-emitting component is activated through automated action of the relay or switch upon detection of a threshold level of carbon dioxide and/or hydrogen gas from said rechargeable battery. This disclosure may further allow for a light emitting or light flashing component to be present and attached to the same electrical distribution component and activated upon detection of the same minimum threshold of gas detection. An additional component may be a separate battery that activates upon loss of power from the plug component to ensure the sensor, fan, and noise emitting component continue in power-up mode during such a loss of external electrical supply. An additional component is a female plug for powering an external device, such as a battery charging unit, which may include a relay or switch that can be turned off once a threshold of gases is met in order to stop further charging of a battery. In addition, a second female plug may be included which would include a relay that can be turned on when the gas threshold is exceeded in order to activate fire suppression systems such as sprinkler systems, water mist systems, alarms, warnings, and other mechanisms to control, suppress or prevent fires or the damage therefrom. Communication between the sensor and fire suppression system may be by an optical, a modulated carrier wave or by conductive wire including, without limit thereto, WiFi or Bluetooth connectivity allowing for remote monitoring, alarms, and controls of the overall system, and also to activate potential external fire suppression devices such as sprinkler systems, high pressure water mist systems, alarms, warnings, door locks and other mechanisms to control, suppress or prevent fires and the damage therefrom.

One particularly valuable embodiment of the early warning device is one that would comprise a female plug, a relay, and a current and voltage analysis unit to monitor the current and voltage being drawn through the female plug. In this instance, the voltage and current analysis unit can be programmed to sense current and voltage patterns which indicate that the battery being charged by the rechargeable battery charger that is plugged into the female plug is leading to an anomalous situation which can be a precursor to the battery going into thermal runaway, catching fire or undergoing another dangerous event. Such current and voltage patterns may involve a high current draw situation, or a drop in voltage or other patterns that are different from the charger when the battery is operating normally. In this case, the relay to the female plug can be turned to the off position and audible, visual and digital alarms can be activated.

Close proximity can be defined as within 40 meters of the rechargable battery, or even within 20 meters of the rechargeable battery, or within 10 meters, or more preferably within 5 meters or even 2 meters. While there is no need for a minimum distance, a practical limit might be 0.5 millimeters, or 1 millimeter or even 2 millimeters, so long as the early warning device is outside the housing of the battery itself, to allow for separate functions and for the detector to operate in the proximity of more than one such battery. Proximity can also be achieved by placing the battery and the early warning device both within a larger chamber, such as a garage or room in a house. Such a chamber may have a total volume of 1000 meters cubed (“m³”) or less, or preferably a total volume of 500 m³ or less, or more preferably a total volume of 200 m³ or less. However, for larger chambers, multiple sensors might be used, and so a true maximum chamber size that is monitored by multiple sensors could have a total volume of 10,000 m³, 100,000 m³ or even 1 million m³. An example of the latter might be a large warehouse with lithium-ion powered fork trucks or material handling equipment, or even an electric vehicle manufacturing facility, which might again be very large. Again, there is no practical limit for the minimum size of this chamber, and it is certainly within this invention to place both the battery and the early warning device into a box that is just large enough to hold both the battery and the early warning device. In this sense, a practical limit may be 10 cubic centimeters, or 50 cubic centimeters, or even 200 cubic centimeters.

Such a device is thus present within an overarching system for early detection and thus external warning to a consumer of a potential thermal runaway issue associated with the rechargeable battery of consumer product. Such a consumer product may be of any type that is commonplace within the consumer industry, including, without limitation, power tools, electronic bikes, laptop computers and pads, electric scooters, hoverboards, drones, basically any device for mobility or other type of electronically based usage that allows for freedom of movement away from a necessary outlet (and thus corded). Such a consumer product may also include electric vehicles, including traditional electric vehicles such as those produced by Tesla, and also electric golf carts, neighborhood electric vehicles, all-terrain vehicles (ATVs), energy storage devices, such as, as one non-limiting example, the Tesla PowerWall, and other similar devices. The capability of this device and thus overall system allows for early detection and presentation of an indication and thus warning to a consumer of problems associated with such rechargeable battery degassing. As of today, there are no consumer-grade sensors provided within this overall industry that will detect the degassing of a lithium-ion battery that is not part of the battery itself. The external placement (within a proper and sufficient proximity of the battery) of such a device, particularly coupled to a high-decibel, high-pitched noise emitting component that is activated upon detection of a low-threshold (but reliable) indication of such lithium-ion (or other rechargeable battery) degassing provides both indication of an imminent thermal runaway event associated with such a battery as well as outward warning of such a situation. This configuration further best ensures the detection and subsequent warning components will not be affected directly upon a short within the battery, thereby providing greater effectiveness for such detection/warning to the consumer/owner/user. Thus, the device is further improved by having a power supply which is separate from the battery itself to prevent mutual malfunction. Such a power supply may be a separate and distinct battery from the battery for which the device is intended to monitor, or it could be plugged into a household plug or other power supply. For example, upon charging of the target battery, the externally placed sensor-containing device (present within a specific diameter/distance/volume from the battery itself) is powered as well, thereby providing a constant monitor of the battery status as it relates to gas release. Typically, carbon dioxide and/or hydrogen are of course present within the atmosphere at certain levels (ambient conditions); however, if a short occurs during charging of the target battery, excessive amounts of either or both gases occur, albeit from small levels that grow over time, as may the presence of carbonates and other volatile organic compounds. Carbonates may comprise cyclic carbonates and chain carbonates. Cyclic carbonates include ethylene carbonate and propylene carbonate, and chain carbonates include diethyl carbonate and ethyl methyl carbonate, as non-limiting examples. The sensor thus is attuned to detect very low levels of carbon dioxide and/or hydrogen at thresholds that are calibrated properly in relation to such ambient levels. At nanosized detection levels thereof, the moment such a minimum level if indicated, the device activates the noise emitting component as a warning with the ability to increase in volume as greater amounts of such gases are detected. This ability to detect such gases at extremely low levels is of utmost importance to provide an early warning of such an imminent thermal runaway event in order to allow a consumer to properly handle such a potentially catastrophic situation.

Carbon dioxide is present in atmosphere at about 400 parts per million “ppm.” The detector must therefore have a sensitivity that is able to finely detect changes in this concentration. As such, a carbon dioxide detector should have a sensitivity that is able to detect changes at least as small as 100 ppm, or even 50 ppm, or preferably 20 ppm or even as small as 10 ppm, or 5 ppm. There is no practical lower limit to the sensitivity of the detector, and it would be useful to have a detector that could detect even a single molecule, if one could be made to exist. However, the minimum range necessary is also important, and must go to a range that is larger than the amount present in atmosphere but need not go as high as 100% concentration. Thus, the detector must have a range at least 500 ppm, or even 5,000 ppm, or even 50,000 ppm, which is 5% of the atmosphere. Since carbon dioxide toxicity is much lower than this, the range need not go higher, so a maximum range might be 10%, or 5%, or even 1% of the atmosphere. Carbon dioxide levels can vary in the atmosphere based on activity in the close proximity. Activities such as breathing, burning candles or fires, or running internal combustion engines can affect the ambient levels. Thus, a minimum threshold of at least 2,000 ppm would be necessary to indicate that a battery fire might be imminent, or even 5,000 ppm, or 10,000 ppm might be necessary to be certain of a fire.

Hydrogen is present in the atmosphere at about 0.5 ppm, which is near zero. The detector must therefore have a sensitivity which can detect reasonable divergences from this, which would be in the same ranges as for the carbon dioxide detector, sensitive to changes at least as small as 100 ppm, or even 50 ppm, or preferably 20 ppm or even as small as 10 ppm, or 5 ppm. The ranges for the hydrogen detector are similar, but perhaps even lower then those necessary for the carbon dioxide detector. Thus, the detector must have a range at least 100 ppm, or even 500 ppm, or even 1,000 ppm, or even 5,000 ppm. Since hydrogen explosivity is lower than this, the range need not go higher, so a maximum range might be 10%, or 5%, or even 1% of the atmosphere. Hydrogen levels are relatively stable in the atmosphere, with very few sources of hydrogen gas other than burning lithium-ion batteries. Thus, the minimum threshold might be as low as 3 ppm, or even 5 ppm, or up to 10 ppm, or preferably above 25 ppm.

Volatile organic compounds are normally present in the atmosphere at concentrations well below 1 ppm, often in the single digits of ppb. The detector must therefore have a sensitivity which can detect reasonable divergences from this, which would be in the same ranges as for the carbon dioxide detector, sensitive to changes at least as small as 100 ppm, or even 50 ppm, or preferably 20 ppm or even as small as 10 ppm, or 5 ppm. The ranges for the volatile organic compound detectors are similar, but perhaps even lower than those necessary for the carbon dioxide detector. Thus, the detector must have a range at least 100 ppm, or even 500 ppm, or even 1,000 ppm, or even 5,000 ppm. There are many sources of volatile organic compounds in the atmosphere, such as spray paints and other paints, varnishes, epoxies and other chemicals. Thus, the minimum threshold should be relatively high, such as 50 ppm, or even 100 ppm, or up to 250 ppm, or preferably above 500 ppm.

It should be noted that rechargeable batteries within consumer devices are quite well-known and their uses are far-flung, certainly. The potential for thermal runaway events is typically associated with manufacturing and/or material issues, as noted above; however, typical usage by consumers, whether in terms of wear and tear or dropping, striking, etc., may also contribute to potential problems with such batteries, albeit most likely in relation to internal material deficiencies, unfortunately. As it is, then, the need for providing effective monitoring of battery conditions over the life and use of such rechargeable consumer products is, again, quite significant. Providing time and a suitable warning to a consumer to realize and assess any such issues with a target battery is important.

In that manner, then, as examples, it has been found that typical lithium-ion batteries, such as 18650s, exhibit thermal runaway characteristics related to levels of charge supplied to the battery itself. Upon an electrical short and creation and release and venting of gases through the opening that indicate over heating within the battery and thermal increases degenerating battery components (separator, for instance) initially occur between 25 seconds and 260 or more seconds prior to full runaway at a common charge, however this can vary greatly depending on the conditions that instigated the thermal runaway. Higher voltage charges result in faster gas generation and venting (and thus shorter times for alerts) while lower charges may increase the time for full runaway (up to even 1,000 seconds). As such, the ability to capture this phenomenon for the protective benefits disclosed herein allows for the utilization of the low gas detection external sensor to activate the warning system (high-decibel noise emitter, potentially coupled with a flashing light component that increases repetition of flashing with higher amounts of gas detected, much like the increased volume of the noise emitter as noted above). With a sufficient alert provided quite quickly and early in relation to gas release from the target battery, a consumer may then, as discussed previously, act properly to detach a charging cord, move the consumer device away from a further source of flammability (remove it from within a home or other edifice, for instance), or prepare for any flame presence (with an extinguisher, for example). The further inclusion of a Wi-Fi or Bluetooth component associated with the device may also allow for an automated external system to provide such beneficial actions (turn off the power, such as if it is through a power strip or through a connected fuse box), not to mention provide a computerized notification if the consumer is not present at that moment. Such a computerized system allows for notification as well to the product supplier, potentially, to alert as to such a target battery issue associated with the manufactured consumer device. Overall, then, the system (and device therein) provides a protective barrier that has heretofore been nonexistent within the consumer products industry. Basically, a separately supplied product (the disclosed device) may be provided and equipped to be attached to a consumer product within the proper proximity of the rechargeable battery thereof for such continuous monitoring of any released gases indicating onset of a thermal runaway event. The early detection capability coupled with the outward warning associated therewith allows for these beneficial results, in other words. Again, as it concerns the other developments and suggestions of battery monitoring has relied solely upon internal battery components and no outward warnings of the type disclosed herein.

The sensor(s) disclosed herein may be of any type that continually monitors the carbon dioxide and/or hydrogen content of the air surrounding the target battery. The fan, as noted above, directs such battery-adjacent air from the opening in the housing towards the sensor(s) to aid in maximum effect of detection of any gas levels. As long as the carbon dioxide and/or hydrogen content remains within a control band, the device remains idle. However, if such gas measurements reach a threshold minimum (outside the control indicating ambient gas levels, in other words), the device may perform any of the following actions: remove power from the female outlets, emit a loud noise from such a component, flash lights (if present) for outward notification, and send an alarm via Wi-Fi or Bluetooth to the devices that are configured to receive such alarms, add power to a second female outlet to trigger auxiliary devices such as sprinkler systems, flame inhibiting gas emissions, cooling or ventilation devices, or other flame retarding or inhibiting techniques. The noise emitter may be of a type that is, for example, electronically based (digitally generated high-pitch, such as two octaves above middle C or higher, or, alternatively, defined as above 3,000 hz, preferably above 5,000 hz, and high-decibel, such as at least 70 db, preferably at least 80 db, most preferably at least 90 db, for instance, with, as alluded to previously, the ability to increase both volume and pitch as the gas level detection level increases). The lights may be LED in nature and may be of a single color or may change color and speed of strobe effect as the amount of gas detected increases, as well. Such lights may be of any number in an array and embedded within a metal or plastic base for structural integrity and suitable configuration on the device itself.

The housing for the sensor(s) is preferably of either a metal material or hard plastic, ostensibly to best ensure protection to the sensor during typical operation of the consumer product itself. The fan may be of any small profile device that accords the necessary transfer of air to the sensor(s). Such may be of metal of plastic, as well. The electrical distribution component within the device to allow for electrical charge to be provided to the component parts is of any typical structure and configuration. The external plug thus may be connected through the housing to the electrical distribution component through standard means in order to permit such electrical supply to the device components.

To restate, then, the device and overall system thereof exhibits the following characteristics: it is free standing in proximity to a target battery and not a part of such a target battery, it is connected to a noise emitting component, it may be connected to a flashing light source, it may be connected to at least one female outlet, it includes a switch or relay to stop power to the at least one female outlet and a separate switch or relay to activate the noise emitting component and possible flashing light source, and may be connected to Wi-Fi or Bluetooth to deliver an alarm to designated external devices, and may include a separate female outlet with accompanying switch or relay to activate this female outlet when the first at least one female outlet is deactivated. Also included in the device is a circuit that contains the capability for all the functions, but for which the power inputs and outputs may not be currently attached. Furthermore, if desired, such a disclosure encompasses at least two devices which are able to communicate with each other through a digital means and are contained within a single chamber, said chamber having a total volume of less than 1 million meters cubed, wherein said chamber also contains at least one rechargeable battery.

### BRIEF DESCRIPTION OF THE DRAWINGS

FIG. 1 is an elevated view of a potential embodiment of the disclosed sensor and alarm device;

FIG. 2 is an isometric view of the device of FIG. 1;

FIG. 3 is an elevated view of a different potential embodiment of the disclosed sensor and alarm device;

FIG. 4 is an isometric view of the device of FIG. 3;

FIG. 5 is a graphical representation of the carbon dioxide and hydrogen measurements in relation to a 5.0 Ah cell with lithium nickel-manganese-cobalt oxide (NMC) cathode.

### DETAILED DESCRIPTION OF THE DRAWINGS AND PREFERRED EMBODIMENTS

The following descriptions and examples are merely representations of potential embodiments of the present disclosure. The scope of such a disclosure and the breadth thereof in terms of claims following below would be well understood by the ordinarily skilled artisan within this area.

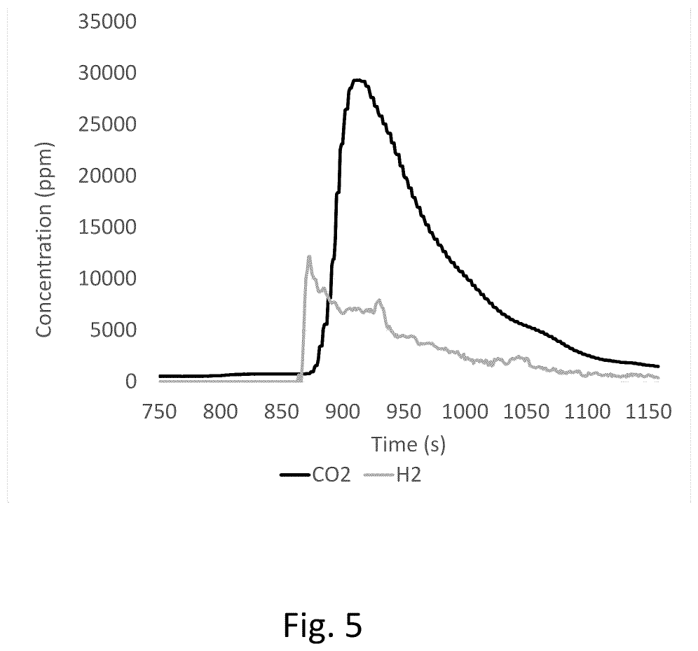

FIGS. 1 and 2 provide an elevated and isometric view, respectively, of one potentially preferred embodiment of the disclosed sensor and alarm device. Such a device 10 is shown in a round shape (disc) with a flat surface including a vent 20 for introduction of gases therein for access to the sensor (not illustrated). Such a sensor is provided with a level of detection for lithium-ion (or other like rechargeable battery) (not illustrated) that measures nanoparticulate size gas presence, as noted above. If and when such a gas is detected at an atypical level, such a sensor activates a sound-generating alert 30 provided with a high-decibel generating speaker that may be attenuated to provide increased volume and/or pitch in relation to detection gas levels (as such a gas measurement increases, the volume and/or pitch may elevate, in other words). Also provided within the device 10 is a test switch/button 40 to allow for user reliability that such a device 10 provides the necessary alarm function. Additionally, as seen in FIG. 2, the device 10 includes an outlet plug for introduction within a wall or power strip outlet (not illustrated) to provide an electrical supply for activation thereof. Alternatively, such a device 10 may also include a battery component (not illustrated) in order to provide electrical charge for operation on demand or if such an external electrical supply is compromised (such as, in one example, the power is disconnected in some fashion).

FIGS. 3 and 4 show a different potential embodiment of a disclosed sensor and alarm device (again in elevated and isometric views, respectively). Such a device 110 is provided in this embodiment as a rectangular structure with a gas vent 120, a speaker/alarm component 130, and test switch/button 140, and a male plug 150 (FIG. 2). Additionally, there is provided a female plug feature 160 for introduction of a male plug from the charging article (not illustrated) of a lithium-ion battery (not illustrated). Such a device 110 further exhibits a depth 170 to properly house such components 120, 130, 140, 160 for full functional capability of each such component within the device 110 itself. In this manner, there is also provided a relay switch (not illustrated) that permits the female plug feature 160 to discontinue charge current to the charging article (not illustrated) upon detection of threshold levels of discharge gases from the lithium-ion battery (not illustrated) that indicate a thermal runaway event is imminent.

There are certainly other possible components that may be incorporated within such a device, including, as noted above, and without limitation, flame retardant sprays, flame extinguishing sprays, and the like.

FIG. 5 provides graphical representations data from the test of the 5.0 Ah NMC cell showing the growth of H₂ and CO₂ over time, indicating the detection capabilities of the disclosed sensor and alarm device in relation to gas discharge levels (carbon dioxide, hydrogen, specifically) associated with an imminent thermal runaway event of a charging lithium-ion battery proximately located thereto.

### EXAMPLES

To test the levels of gases emitted by battery fires, several batteries were sent into thermal runaway through overcharging thereof.

Within a controlled environment, cells were confined within a fixed volume container of approximately 0.5 cubic meters. These cells were then subjected to various overcharging at a rate of 1C until failure. To monitor and quantify the resulting gassing and thermal event, the exhaust outlet of the fixed volume container was retrofitted with sensors capable of tracking concentrations of CO₂ and H₂.

Two different cells were tested, to show the universality of the detection strategy.
4.5 Ah, lithium cobalt oxide (LCO) cathode, graphite anode, wound pouch cell, designed for cell phones.
5.0 Ah lithium nickel manganese cobalt oxide (NMC) cathode with 8:1:1 ratio; graphite anode, stacked pouch cell, small prototype using automotive electric vehicle chemistry and design.

In separate experiments, the CO₂ and H₂ concentrations were measured as the cell was overcharged. The ambient measurements of each gas, and the peak concentration were each measured. For CO₂, the measurement device was an Amphenol Telaire T6615 CO₂ Sensor Module. For H₂ for the 4.5 Ah LCO #1 cell, the measurement device was a Smart Sensor AS8909 Hydrogen Detector. For the NMC 5 Ah cell, an Amphenol AX221058S hydrogen sensor was used to detect H₂. The results are shown in Table 1. In addition, the 5 Ah NMC cell vented several seconds before going into thermal runaway, which resulted in a hydrogen peak of 642 ppm associated with the venting.

TABLE 1

| | | | | | | Time to |
|---|---|---|---|---|---|---|
| | H2 | H2 | Time to | CO2 | | CO2 |
| Cell | Ambient | Peak | H2 Peak | Ambient | CO2 Peak | Peak |
| 4.5 Ah | 0 | 957 | 36 sec | <500 ppm | 33,000 ppm | 36 sec |
| LCO #1 | | | | | | |
| 4.5 Ah | | | | <500 ppm | 47,500 ppm | 53 sec |
| LCO #2 | | | | | | |
| 5 Ah | 0 | 12,185 | 8 sec | <500 ppm | 42,000 ppm | 25 sec |
| NMC | | | | | | |

With these results it is evident that the device and system thereof imparts a beneficial protective methodology for safer utilization of rechargeable consumer products. Such an early detection and effective warning protocol for consumers accords an overarching platform for safety that has heretofore been nonexistent within the pertinent industries.

Having described the disclosure in detail it is obvious that one skilled in the art will be able to make variations and modifications thereto without departing from the scope of the present disclosure. Accordingly, the scope of the present disclosure should be determined only by the claims appended hereto.

What we claim is:

1. An early warning device for placement within close proximity of a rechargeable battery associated with an electrical device, said proximity which is external to said rechargeable battery, said early warning device comprising: i) at least one sensor for nanosize detection of a gas commonly emitted from said rechargeable battery when overheated, when it goes into thermal runaway, or explodes; ii) a high-decibel high-pitch noise emitting component generating such a noise of at least 70 db and a pitch of least 3,000 hz; iii) an electrical distribution component for providing electrical power to said at least one sensor and said noise emitting component; iv) a relay or switch for activation of said noise emitting component; and v) a power source connected to said electrical distribution component; wherein said noise emitting component is activated through automated action of said relay or switch upon detection of a concentration of gas exceeding minimum gas threshold from said rechargeable battery by said at least one sensor.

2. The device of claim 1 wherein said device further comprises a housing around said early warning device.

3. The device of claim 1 wherein said sensor is present within said housing; and wherein said housing includes an opening therein for passage of gases therethrough for exposure to said at least one sensor.

4. The device of claim 3 wherein said high-decibel high-pitch noise emitting component is present within or attached thereto said housing; and wherein said housing includes a fan component to direct external gases to said at least one sensor.

5. The device of claim 1 where the minimum gas threshold to activate said at least one sensor is 5 parts per million.

6. The device of claim 1 wherein said gas commonly emitted from said rechargeable battery when overheated or when it goes into thermal runaway or explodes is carbon dioxide.

7. The device of claim 5 where said minimum gas threshold is 2,000 ppm.

8. The device of claim 1 wherein said gas commonly emitted from said rechargeable battery when overheated or when it goes into thermal runaway or explodes is a volatile organic compound.

9. The device of claim 7 where said minimum gas threshold is 50 parts per million.

10. The device of claim 1 where said power source is a battery.

11. The device of claim 1 where said power source is a plug component.

12. The device of claim 2 wherein said device further comprises a fan attached thereto said housing to direct gases to said opening.

13. The device of claim 1 wherein said device further comprises a light emitting/flashing component attached to said electrical distribution component and activated upon detection of the same minimum threshold of gas detection.

14. The device of claim 11 wherein said device further comprises a separate battery that activates upon loss of power from said plug component to ensure the sensor, fan, and noise emitting component continue in power-up mode during such a loss of external electrical supply.

15. The device of claim 1 wherein said device further comprises a Wi-Fi or Bluetooth connector to connect said at least one sensor to a Wi-Fi network and allow remote monitoring, alarms, and controls of the overall system.

16. The device of claim 1 wherein the device is within 40 meters of said rechargeable battery.

17. The device of claim 1 wherein said rechargeable battery and said early warning device are both within a larger chamber, such chamber having a total volume of 1000 meters cubed or less.

18. A system of early warning devices of claim 1 comprising at least two devices which are able to communicate with each other through a digital means and are contained within a single chamber, said chamber having a total volume of less than 1 million meters cubed, where said chamber also contains at least one rechargeable battery.
